(19) United States
(12) Patent Application Publication
(10) Pub. No.: US 2015/0112891 A1
(43) Pub. Date: Apr. 23, 2015

(54) INFORMATION PROCESSOR, INFORMATION PROCESSING METHOD, AND PROGRAM

(71) Applicant: SONY CORPORATION, Tokyo (JP)

(72) Inventors: Yusuke Watanabe, Tokyo (JP); Masato Ito, Tokyo (JP); Masahiro Tamori, Kanagawa (JP)

(73) Assignee: SONY CORPORATION, Tokyo (JP)

(21) Appl. No.: 14/398,586

(22) PCT Filed: Jun. 5, 2013
(86) PCT No.: PCT/JP2013/065617

§ 371 Date: Nov. 3, 2014

(30) Foreign Application Priority Data
Jun. 13, 2012 (JP) 2012-133461

(51) Int. Cl. G06N 7/00; G06N 5/04

(52) U.S. Cl. CPC G06N 7/005; G06N 5/048
USPC 706/1

(57) ABSTRACT

The present technique relates to an information processor, an information processing method, and a program by which an objective variable value is efficiently and highly precisely estimated.

A log acquisition unit acquires objective time-series data corresponding to the objective variable to be estimated, and a plurality of pieces of explanatory time-series data being time-series data corresponding to a plurality of explanatory variables explaining the objective variable. A model parameter update unit learns a parameter of a probability model using the acquired objective time-series data and plurality of pieces of explanatory time-series data. A log selection unit selects, based on the parameter of the probability model having been obtained by the learning, the explanatory variable corresponding to the explanatory time-series data acquired by the log acquisition unit. An estimation unit estimates the objective variable value, using the plurality of pieces of explanatory time-series data having been acquired by the log acquisition unit based on a selection result of the selection unit. The present technique may be applied to for example an information processor for estimating device power consumption.

### TECHNICAL FIELD

The present technique relates to an information processor, an information processing method, and a program, and particularly, an information processor, an information processing method, and a program by which an objective variable value is efficiently and highly precisely estimated.

### BACKGROUND ART

Techniques for estimating power consumption of electronic devices have been provided in which a load factors and the like of a CPU being the electronic device component are defined as explanatory variables, power consumption of the electronic device is modeled in the form of a line of the explanatory variables and power coefficients thereof, and the power consumption is estimated based on an operating state of the component (e.g. see Patent Document 1).

### CITATION LIST

### Patent Document

Patent Document 1: JP 2010-22533 A

### SUMMARY OF THE INVENTION

### Problems to be Solved by the Invention

However, the technique according to Patent Document 1 uses only an operating state (value) of the component at a time t in order to estimate power consumption at the time t. Therefore, the technique according to Patent Document 1 cannot estimate power consumption in consideration of an operating status history up to the time t.

Further, in the technique according to Patent Document 1, a kind of acquired data (data corresponding to explanatory variable) used for the estimation of power consumption needs to be determined and selected by a person to prevent the problem of multicollinearity.

The present technique is made in view of such circumstances, and it is an object of the present technique to efficiently and highly precisely estimate an objective variable value by automatically selecting the acquired data taking into account the operating status history up to the current time.

### Solutions to Problems

According to one aspect of the present technique, an information processor includes an acquisition unit, a learning unit, a selection unit, and an estimation unit. The acquisition unit acquires objective time-series data being time-series data corresponding to an objective variable to be estimated and a plurality of pieces of explanatory time-series data being time-series data corresponding to a plurality of explanatory variables for explaining the objective variable. The learning unit learns a parameter of a probability model, using the acquired objective time-series data and plurality of pieces of explanatory time-series data. The selection unit selects, based on the parameter of the probability model having been obtained by the learning, the explanatory variables corresponding to the explanatory time-series data to be acquired by the acquisition unit. The estimation unit estimates the objective variable value using the plurality of pieces of explanatory time-series data having been acquired by the acquisition unit based on a selection result of the selection unit.

According to one aspect of the present technique, in an information processing method, the information processor acquires objective time-series data being time-series data corresponding to an objective variable to be estimated, and a plurality of pieces of explanatory time-series data being time-series data corresponding to a plurality of explanatory variables for explaining the objective variable, learns a parameter of a probability model using the acquired objective time-series data and plurality of pieces of explanatory time-series data, selects, based on the parameter of the probability model having been obtained by the learning, the explanatory variables corresponding to the explanatory time-series data to be acquired, and estimates an objective variable value using the plurality of pieces of explanatory time-series data having been acquired based on a selection result.

According to one aspect of the present technique, a program causes a computer to function as the acquisition unit, the learning unit, the selection unit, and the estimation unit.

The acquisition unit acquires objective time-series data being time-series data corresponding to an objective variable to be estimated and a plurality of pieces of explanatory time-series data being time-series data corresponding to a plurality of explanatory variables for explaining the objective variable. The learning unit learns a parameter of a probability model using the acquired objective time-series data and plurality of pieces of explanatory time-series data. The selection unit selects, based on the parameter of the probability model having been obtained by the learning, the explanatory variables corresponding to the explanatory time-series data to be acquired by the acquisition unit. The estimation unit estimates the objective variable value using the plurality of pieces of explanatory time-series data having been acquired by the acquisition unit based on a selection result of the selection unit.

In one aspect of the present technique, objective time-series data being time-series data corresponding to an objective variable to be estimated, and a plurality of pieces of explanatory time-series data being time-series data corresponding to a plurality of explanatory variables for explaining the objective variable are acquired. The acquired objective time-series data and the plurality of pieces of explanatory time-series data are used to learn a parameter of a probability model. The explanatory variable corresponding to the explanatory time-series data acquired is selected based on the parameter of the probability model having been obtained by the learning. The objective variable value is estimated using the acquired plurality of pieces of explanatory time-series data having been acquired based on a selection result.

It is noted that the program can be provided by being transmitted through a transmission medium or by being recorded in a recording medium.

The information processor may be an independent apparatus or an internal block constituting one apparatus.

### Effects of the Invention

According to one aspect of the present technique, an objective variable value can be estimated efficiently and highly precisely.

### BRIEF DESCRIPTION OF DRAWINGS

FIG. 1 is a schematic view illustrating a device power consumption estimation process.

FIG. 2 is a block diagram illustrating an exemplary configuration according to an embodiment of an information processor to which the present technique is applied.

FIG. 3 is a flowchart illustrating a data collection process.

FIG. 4 is a flowchart illustrating a model parameter learning process.

FIG. 5 is a flowchart illustrating a power consumption estimation process.

FIG. 6 is a view illustrating an HMM graphical model.

FIG. 7 is a flowchart illustrating a model parameter updating process.

FIG. 8 is a block diagram illustrating an exemplary configuration according to an embodiment of a computer to which the present technique is applied.

### MODE FOR CARRYING OUT THE INVENTION

[Outline of Processing of Information Processor]

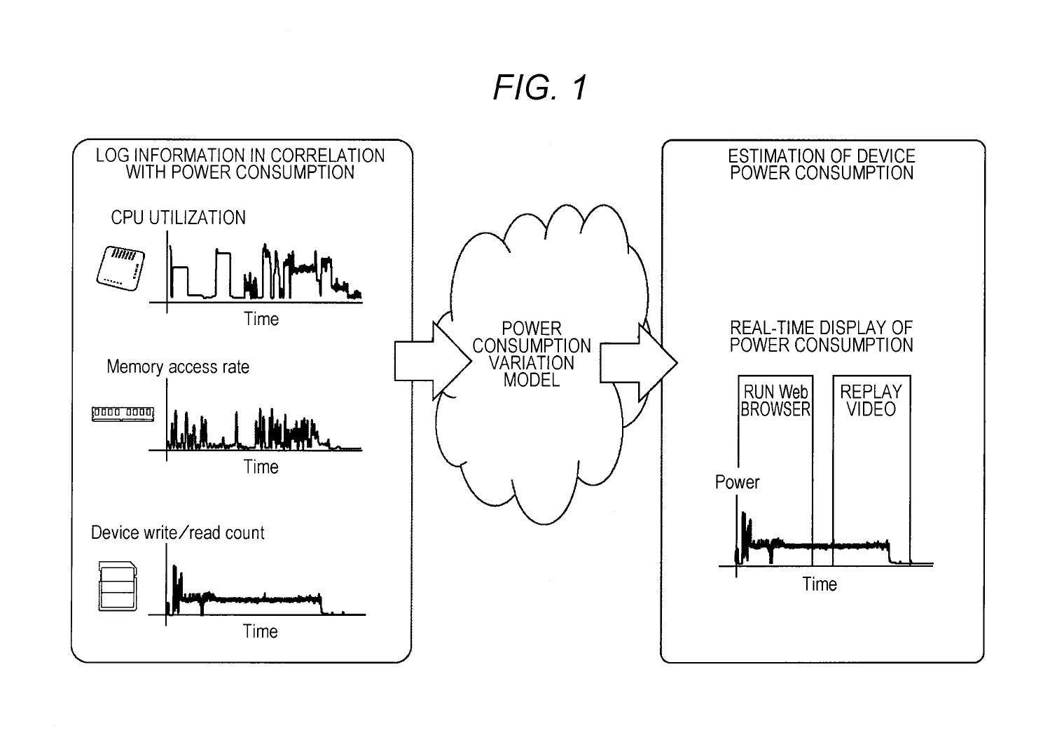

First, an outline of a device power consumption estimation process carried out in an information processor to which the present technique is applied will be described with reference to FIG. 1.

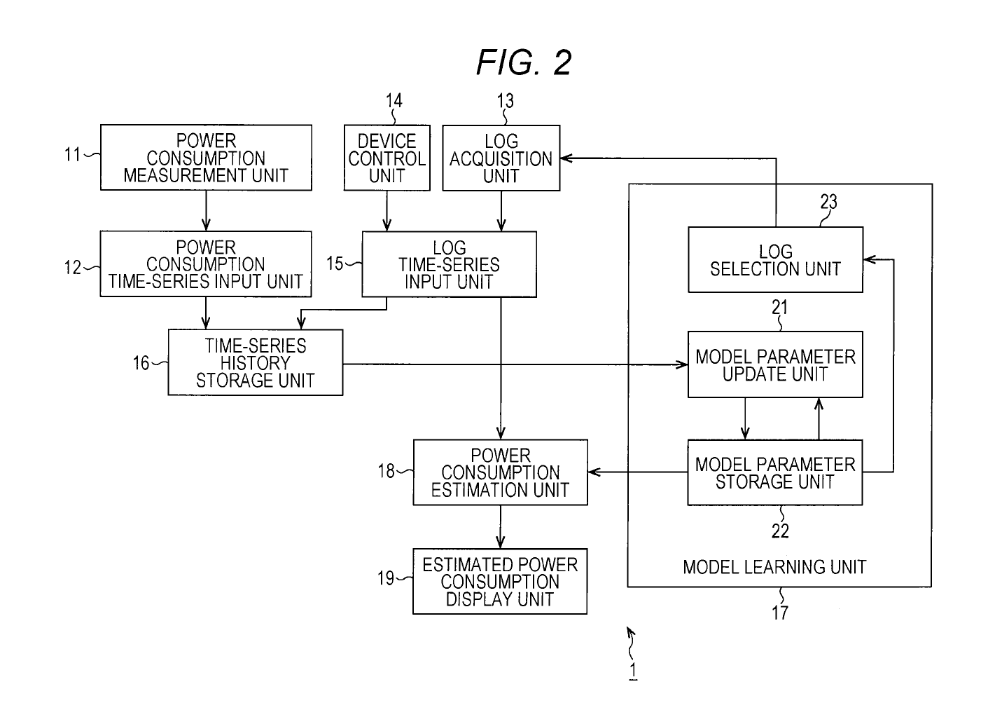

The information processor 1 illustrated in FIG. 2, which will be described below, acquires time-series data representing an operating state of a predetermined component in a device (electronic device). It is noted that the time-series data acquired is, for example, CPU utilization, memory (RAM) access rate, write/read count of a removable medium, as illustrated in FIG. 1. The information processor 1 also simultaneously acquires time-series data about device power consumption upon acquiring the time-series data representing an operating state.

The information processor 1 preliminarily learns a relationship between a plurality of kinds of operating states and power consumption using a predetermined learning model. The learning model learned by the information processor 1 is hereinafter referred to as a power consumption variation model.

After the power consumption variation model (parameter) has been determined by learning, the information processor 1 uses the learned power consumption variation model to estimate current device power consumption based on only newly input time-series data representing the plurality of kinds of operating states. The information processor 1 displays for example current power consumption as an estimation result, on a display in real time.

Processing of the information processor 1 includes two major processes. A first process is a learning process for learning the relationship between a plurality of kinds of operating states and power consumption using a predetermined learning model. A second process is a power consumption estimation process for estimating current device power consumption using the learning model having been obtained in the learning process.

The device (electronic device) includes a mobile terminal such as a smartphone or a tablet terminal, or a stationary personal computer. Further, the device may be a TV set, a content recorder/player, or the like. The information processor 1 may be incorporated in part of a device having power consumption to be estimated, or may include an apparatus different from the device to be estimated and configured to be connected to the device to be estimated in order to perform estimation. The information processor 1 may be formed as an information processing system including a plurality of apparatuses.

[Functional Block Diagram of Information Processor]

FIG. 2 is a block diagram illustrating a functional configuration of the information processor 1.

The information processor 1 includes a power consumption measurement unit 11, a power consumption time-series input unit 12, a log acquisition unit 13, a device control unit 14, a log time-series input unit 15, a time-series history storage unit 16, a model learning unit 17, a power consumption estimation unit 18, and an estimated power consumption display unit 19.

The power consumption measurement unit 11 includes for example, a power meter (clamp meter), a tester, or an oscilloscope. The power consumption measurement unit is connected to a power line of the device, measures the device power consumption at each time, and outputs a measurement result to the power consumption time-series input unit 12.

The power consumption time-series input unit 12 accumulates, for a predetermined time period, a power consumption value at each time, fed from the power consumption measurement unit 11. The power consumption time-series input unit 12 thereby generates time-series data of power consumption values. The generated time-series data of power consumption values (hereinafter also referred to as time-series power consumption data) includes sets of an acquisition time and a power consumption value, collected for a predetermined time period.

The log acquisition unit 13 acquires, as log information, data representing an operating state of a predetermined component in the device. The log acquisition unit 13 simultaneously acquires a plurality of kinds of log information, and outputs the acquired information to the log time-series input unit 15. The kind of log information acquired by the log acquisition unit 13 includes CPU utilization, GPU utilization, Wi-Fi traffic, mobile communication traffic (3G traffic), display brightness, or paired data of a running applications list and CPU utilization, but the kind of log information is not limited to them.

In the learning process of the power consumption variation model, the device control unit 14 controls the devices making various states, in order to learn power consumption in various possible states as the power consumption variation model. For example, the device control unit 14 simultaneously starts and runs a plurality of kinds of applications such as a game and spreadsheet processing software, or executes or stops data communication so that the device executes the possible combined operating states.

In the learning process, the log time-series input unit 15 accumulates, for a predetermined time period, log information representing an operating state at each time, fed from the log acquisition unit 13. The log time-series input unit 15 thereby outputs resultant time-series log data to the time-series history storage unit 16.

Additionally, in the power consumption estimation process, the log time-series input unit 15 accumulates, for a predetermined time period, the log information at each time, fed from the log acquisition unit 13. The log time-series input unit 15 thereby outputs the resultant time-series log data to the power consumption estimation unit 18.

It is noted that, when the kind of log information is, for example, the paired data of a running applications list and CPU utilization, the running applications list is fed from the device control unit 14 to the log time-series input unit 15, and the CPU utilization is fed from the log acquisition unit 13 to the log time-series input unit 15.

The log time-series input unit 15 performs data processing such as abnormal value removal processing, as required. The abnormal value removal processing can employ, for example, a process provided in “On-line outlier detection and data cleaning”, Computers and Chemical Engineering 28 (2004), 1635-1647, by Liu et al.

The time-series history storage unit 16 stores the time-series power consumption data fed from the power consumption time-series input unit 12 and the time-series log data fed from the log time-series input unit 15. The time-series power consumption data and the time-series log data having been stored in the time-series history storage unit 16 are used when the model learning unit 17 learns (updates) the power consumption variation model.

The model learning unit 17 includes a model parameter update unit 21, a model parameter storage unit 22, and a log selection unit 23.

The model parameter update unit 21 uses the time-series power consumption data and the time-series log data having been stored in the time-series history storage unit 16 to learn the power consumption variation model, and causes the model parameter storage unit 22 to store a resultant parameter of the power consumption variation model. Hereinafter, the parameter of the power consumption variation model is also simply referred to as a model parameter.

Further, when new time-series power consumption data and new time-series log data are stored in the time-series history storage unit 16, the model parameter update unit 21 uses the new time-series data to update the parameter of the power consumption variation model being stored in the model parameter storage unit 22.

The model parameter update unit 21 employs, as the probability model representing the power consumption variation model, a hybrid HMM+RVM being a probability model of a relevance vector machine (RVM) and a hidden Markov model (HMM) representing an operation state of the device in a hidden state S. Detailed description of HMM+RVM will be made later.

The model parameter storage unit 22 stores the parameter of the power consumption variation model having been updated (learned) by the model parameter update unit 21. The parameter of the power consumption variation model being stored in the model parameter storage unit 22 is fed to the power consumption estimation unit 18.

The log selection unit 23 selectively controls unnecessary (kind of) log information from the plurality of kinds of log information acquired by the log acquisition unit 13. More specifically, the log selection unit 23 determines the unnecessary log information based on the parameter of the power consumption variation model (value) being stored in the model parameter storage unit 22. The log selection unit 23 controls the log acquisition unit 13 based on a determination result so that the log information determined to be unnecessary is not acquired.

The power consumption estimation unit 18 acquires, from the model parameter storage unit 22, the parameter of the power consumption variation model having been obtained in the learning process. In the power consumption estimation process, the power consumption estimation unit 18 inputs, to the learned power consumption variation model, the time-series log data within a predetermined time period before the current time, fed from the log time-series input unit 15. Further, the power consumption estimation unit 18 estimates a power consumption value at the current time. The power consumption value resulted from the estimation is fed to the estimated power consumption display unit 19.

The estimated power consumption display unit 19 displays the power consumption value at the current time, fed from the power consumption estimation unit 18, in a predetermined manner. For example, the estimated power consumption display unit 19 digitally displays the power consumption value at the current time, or graphically displays a transition of the power consumption values within the predetermined time period before the current time.

The information processor 1 is configured as described above.

[Flowchart of Data Collection Process]

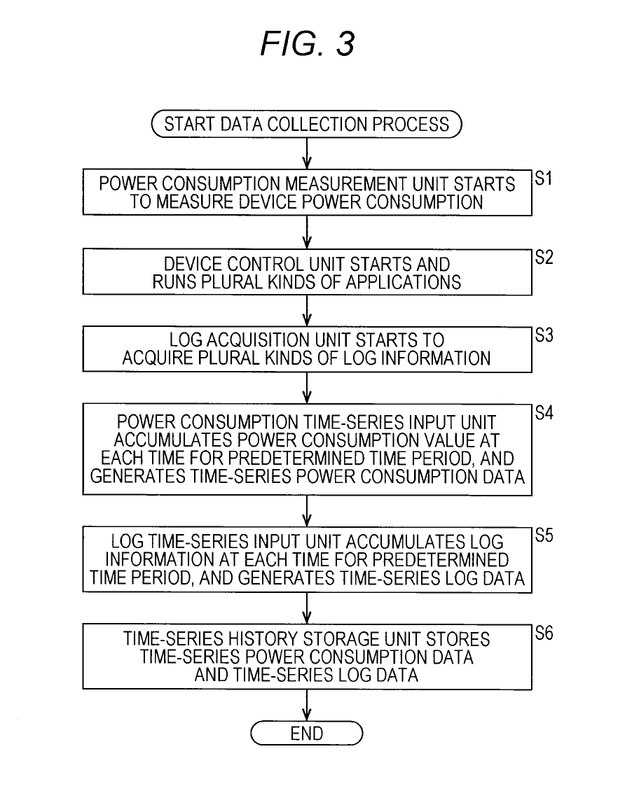

A data collection process will be described with reference to a flowchart of FIG. 3. The data collection process is part of the learning process of the information processor 1, and is configured to collect data for calculating the model parameter.

First, in step S1, the power consumption measurement unit 11 starts to measure the device power consumption. After the process of step S1, the power consumption is measured at predetermined time intervals, and measurement results are output sequentially to the power consumption time-series input unit 12.

In step S2, the device control unit 14 starts and runs the plurality of kinds of applications.

In step S3, the log acquisition unit 13 starts to acquire the plurality of kinds of log information. After the process of step S3, the plurality of kinds of log information is acquired at predetermined time intervals, and sequentially output to the log time-series input unit 15.

The processes of steps S1 to S3 may be performed in any order. Additionally, the processes of steps S1 to S3 may be performed simultaneously.

In step S4, the power consumption time-series input unit 12 accumulates, for a predetermined time period, the power consumption value at each time, fed from the power consumption measurement unit 11. The power consumption time-series input unit 12 thereby generates the time-series power consumption data. The power consumption time-series input unit 12 feeds the generated time-series power consumption data to the time-series history storage unit 16.

In step S5, the log time-series input unit 15 accumulates, for a predetermined time period, the log information at each time, fed from the log acquisition unit 13. The log time-series input unit 15 thereby generates the time-series log data. The log time-series input unit 15 feeds the generated time-series log data to the time-series history storage unit 16.

In step S6, the time-series history storage unit 16 stores the time-series power consumption data fed from the power consumption time-series input unit 12, and the time-series log data fed from the log time-series input unit 15.

After the processes of steps S1 to S6 have been performed, learning data (set of time-series power consumption data and time-series log data) are stored in the time-series history storage unit 16. The learning data is obtained under a predetermined operating condition controlled by the device control unit 14 in step S2.

The information processor 1 variously changes the operating condition to be different from each other, repeats the above-mentioned data collection process predetermined times, and accumulates the learning data in the various possible operating states. That is, the information processor 1 variously changes the process of step S2, repeats the processes of steps S1 to S6 predetermined times, and stores the learning data in the various possible operating state in the time-series history storage unit 16.

[Flowchart of Model Parameter Learning Process]

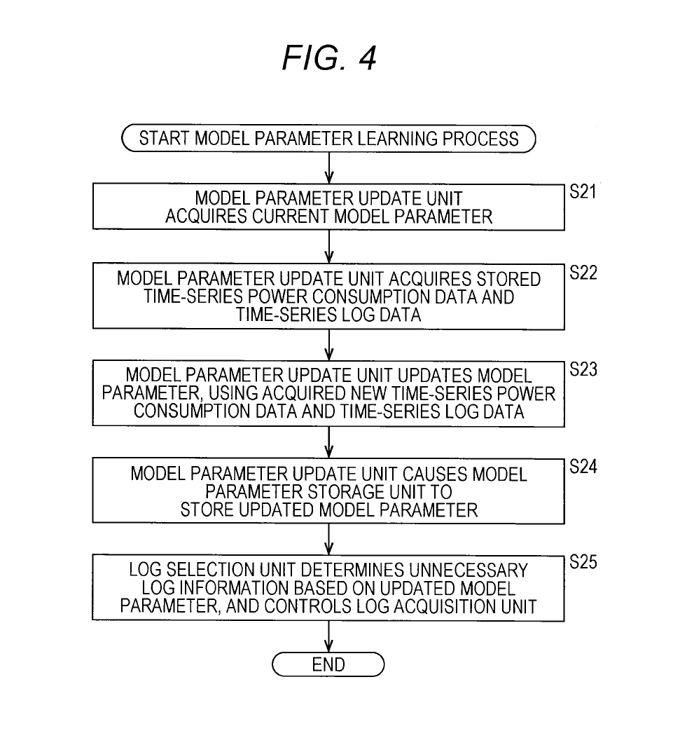

Next, a model parameter learning process will be described with reference to a flowchart of FIG. 4. The model parameter learning process is part of the learning process of the information processor 1, and is configured to derive the model parameter, using the learning data having been collected in the data collection process.

First, in step S21, the model parameter update unit 21 acquires a current model parameter from the model parameter storage unit 22. When the model parameter update unit 21 learns the power consumption variation model for the first time, an initial value of the model parameter is stored in the model parameter update unit 21.

In step S22, the model parameter update unit 21 acquires the time-series power consumption data and the time-series log data which are stored in the time-series history storage unit 16.

In step S23, the model parameter update unit 21 updates the model parameter, with the current model parameter acquired from the model parameter storage unit 22 as the initial value, using the new time-series power consumption data and the new time-series log data, both acquired from the time-series history storage unit 16.

In step S24, the model parameter update unit 21 feeds the updated model parameter to the model parameter storage unit 22, and causes the model parameter storage unit 22 to store the updated model parameter. The model parameter storage unit 22 writes the updated model parameter fed from the model parameter update unit 21 over the current model parameter, and stores the overwritten parameter.

In step S25, the log selection unit 23 determines the unnecessary log information based on the updated model parameter being stored in the model parameter storage unit 22. The log selection unit 23 controls the log acquisition unit 13 based on a determination result so that the log information determined to be unnecessary is not acquired. The selection control of the log selection unit 23 is reflected in a log information acquisition process (process of step S3) performed by the log acquisition unit 13, from the next time.

As described above, the learning (update) of the model parameter is performed, using the new time-series power consumption data and the new time-series log data, both stored in the time-series history storage unit 16.

[Flowchart of Power Consumption Estimation Process]

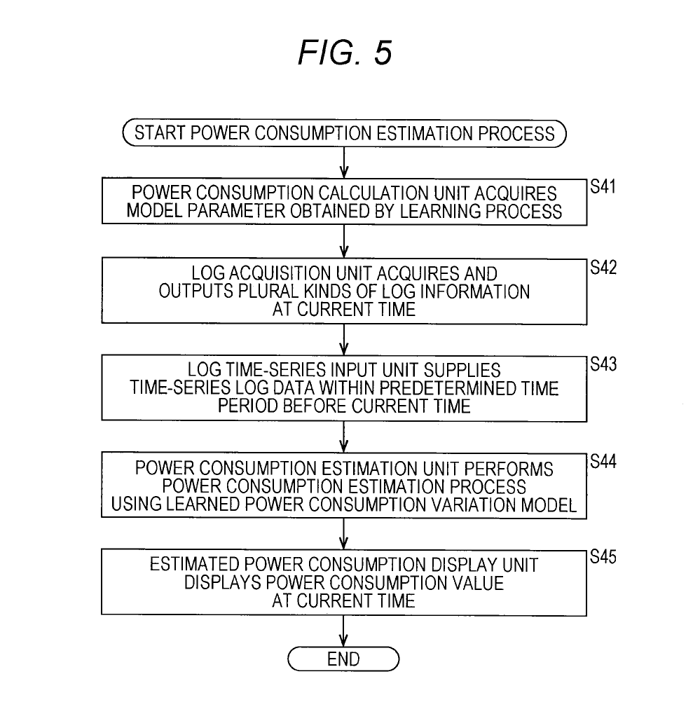

Next, the power consumption estimation process for estimating the power consumption in a current operating state using the learned model parameter, will be described with reference to a flowchart of FIG. 5.

First, in step S41, the power consumption estimation unit 18 acquires the model parameter having been obtained by the learning process, from the model parameter storage unit 22.

In step S42, the log acquisition unit 13 acquires the plurality of kinds of current log information at the current time, and outputs the log information to the log time-series input unit 15. In the process of step S42, only the kind of log information selectively controlled by the log selection unit 23 is acquired.

In step S43, the log time-series input unit 15 temporarily stores log information at the current time, fed from the log acquisition unit 13. The log time-series input unit 15 feeds the time-series log data within the predetermined time period before the current time to the power consumption estimation unit 18. The log information at the current time is fed from the log acquisition unit 13 to erase old log information which does not need to be stored.

In step S44, the power consumption estimation unit 18 performs the power consumption estimation process using the learned power consumption variation model. That is, the power consumption estimation unit 18 inputs the time-series log data from the log time-series input unit 15 to the power consumption variation model, and estimates (calculates) the power consumption value at the current time. The power consumption value resulted from the estimation is fed to the estimated power consumption display unit 19.

In step S45, the estimated power consumption display unit 19 displays the power consumption value (estimation value) at the current time, and terminates the process, wherein the power consumption value at the current time is fed from the power consumption estimation unit 18 in a predetermined manner.

The above-mentioned processes of steps S41 to S45 are performed, for example, at each time at which the log acquisition unit 13 acquires the new log information.

[Detailed Description of HMM+RVM]

Next, in the present embodiment, the HMM+RVM will be described in detail which is employed as the learning model for learning variation in device power consumption.

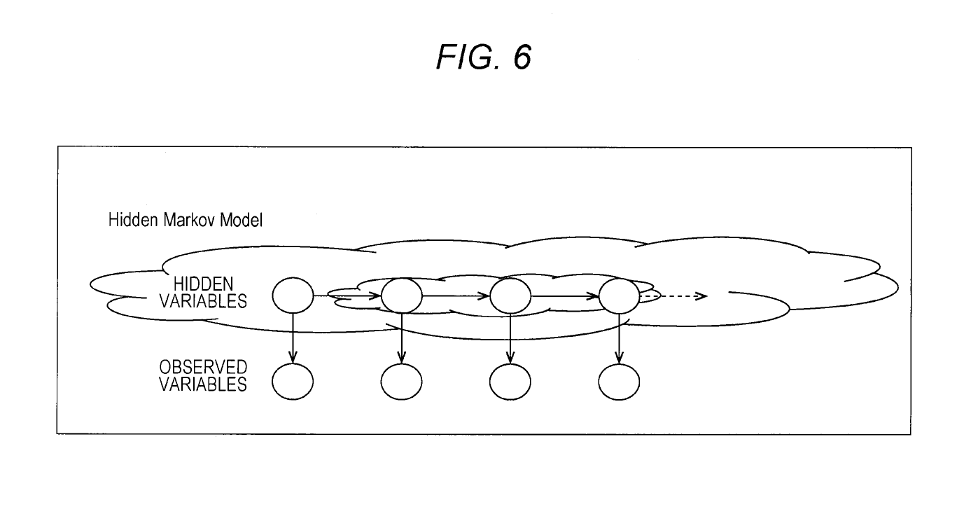

First, a general probability model of the HMM will be described. FIG. 6 illustrates a graphical model of the HMM.

A joint probability of a hidden variable Sₜ and the observed data Xₜ and Yₜ is expressed by following formula (1), wherein observed time-series power consumption data is denoted by Y={Y₁, Y₂, Y₃, . . . , Yₜ, . . . , Y_{T}}, observed time-series log data is denoted by X={X₁, X₂, X₃, . . . , Xₜ, . . . , X_{T}}, and time-series data of hidden variables corresponding to hidden states of possible back side devices is denoted by S={S₁, S₂, S₃, . . . , Sₜ, . . . , S_{T}}.

$$\begin{matrix} [ Mathematical Formula 1 ] & \\ P ( \{ {S}_{t} , {Y}_{t} , {X}_{t} \} ) = P ( {S}_{1} ) P ( {X}_{1} \vert {S}_{1} ) P ( {Y}_{1} \vert {S}_{1} ) {\prod }_{t = 2}^{T} P ( {S}_{t} \vert {S}_{t - 1} ) P ( {X}_{t} \vert {S}_{t} ) P ( {Y}_{t} \vert {S}_{t} ) & ( 1 )\end{matrix}$$

In formula (1), Yₜ represents a measured value yₜ of power consumption of the consumption measurement unit 11 at a time t, and is one-dimensional data. Xₜ is the plurality of kinds (Dx pieces) of log information xₜ¹, xₜ², . . . , xₜ^{Dx} at the time t acquired at the log acquisition unit 13, and denotes Dx-dimensional vector.

In formula (1), P(S₁) denotes an initial probability, P(Sₜ|Sₜ₋₁) denotes a state transition probability of transition from a hidden state Sₜ₋₁ to a hidden state Sₜ, and P(Yₜ|Sₜ) and P(Xₜ|Sₜ) denotes observation probabilities. Observation probabilities P(Yₜ|Sₜ) and P(Xₜ|Sₜ) are calculated using the following formulas (2) and (3), respectively.

$$\begin{matrix} [ Mathematical Formula 2 ] & \\ P ( {Y}_{t} \vert {S}_{t} ) = {{β}^{- 1 / 2} ( 2 π )}^{- 1 / 2} exp ( \frac{- 1}{2} ( {Y}_{t} - {ρ}_{{S}_{t}} ) {β}^{- 1} ( {Y}_{t} - {ρ}_{{S}_{t}} ) ) & ( 2 ) \\ P ( {X}_{t} \vert {S}_{t} ) = {\vert {Σ}_{{S}_{t}} \vert}^{- 1 / 2} {( 2 π )}^{- Dx / 2} exp ( \frac{- 1}{2} {( {X}_{t} - {μ}_{{S}_{t}} )}^{T} {\sum }_{{S}_{t}}^{- 1} ( {X}_{t} - {μ}_{{S}_{t}} ) ) & ( 3 )\end{matrix}$$

In formula (2), ρ_{St} denotes a mean value of power consumption (output Y) in the hidden state Sₜ, and β denotes a magnitude (variance) of Gaussian noise on the output Y. The magnitude β of Gaussian noise on the output Y is defined to be independent of the hidden state, but it can be readily defined to be dependent on the hidden state. Similarly, in formula (3), μ_{St} denotes a mean value of the log information (input X) in the hidden state Sₜ, and E_{St} denotes variance of input X. T denotes transpose.

In contrast to the general probability model of the above-mentioned HMM, the present embodiment employs, as the power consumption variation model, the probability model of the HMM+RVM which is expressed by the following formula (4).

$$\begin{matrix} [ Mathematical Formula 3 ] & \\ P ( \{ {S}_{t} , {Y}_{t} , {X}_{t} , {w}_{{S}_{t}} \} ) = P ( {S}_{1} ) P ( {X}_{1} , {Y}_{1} \vert {S}_{1} , {w}_{{S}_{1}} ) {\prod }_{t = 2}^{T} P ( {S}_{t} \vert {S}_{t - 1} ) P ( {X}_{t} , {Y}_{t} \vert {S}_{t} , {w}_{{S}_{t}} ) {\prod }_{s} P ( {w}_{S} ) & ( 4 )\end{matrix}$$

In formula (4), w_{St} denotes a linear regression coefficient of the input X and the output Y in the hidden state Sₜ, and P(w_{S}) denotes a prior probability distribution of linear regression coefficients w_{S}. As shown in formula (5), a Gaussian distribution with mean ν₀ and variance α⁻¹ (inverse of α) is assumed for the prior probability distribution P(w_{S}) of the linear regression coefficients w_{S}.

$$\begin{matrix}[ Mathematical Formula 4 ] & \\ P ( {w}_{S} ) = {\vert α \vert}^{- 1 / 2} {( 2 π )}^{- Dx / 2} exp ( \frac{- 1}{2} {( {w}_{S} - {v}_{0} )}^{T} α ( {w}_{S} - {v}_{0} ) ) & ( 5 )\end{matrix}$$

It is noted that the mean ν₀ is set to 0, and the variance α⁻¹ is a diagonal matrix.

An observation probability P(Xₜ, Yₜ|Sₜ, w_{St}) in formula (4) is expressed as a product of an observation probability P(Yₜ|Xₜ, w_{St}) and the observation probability P(Xₜ|Sₜ) as shown in formula (6). An observation probability P(Yₜ|Xₜ, w_{St}) and the observation probability P(Xₜ|Sₜ) are expressed as formulas (7) and (8), respectively.

$$\begin{matrix} [ Mathematical Formula 5 ] & \\ P ( {X}_{t} , {Y}_{t} \vert {S}_{t} , {w}_{{S}_{t}} ) = P ( {Y}_{t} \vert , {X}_{t} , {w}_{{S}_{t}} ) P ( {X}_{t} \vert {S}_{t} ) & ( 6 ) \\ P ( {Y}_{t} \vert {X}_{t} , {w}_{{S}_{t}} ) = {{β}^{- 1 / 2} ( 2 π )}^{- 1 / 2} exp ( \frac{- 1}{2} {( {Y}_{t} - {w}_{{S}_{t}}^{T} {X}_{t} )}^{T} {β}^{- 1} ( {Y}_{t} - {w}_{{S}_{t}}^{T} {X}_{t} ) ) & ( 7 ) \\ P ( {X}_{t} \vert {S}_{t} ) = {\vert {\sum }_{{S}_{t}} \vert}^{- 1 / 2} {( 2 π )}^{- Dx / 2} exp ( \frac{- 1}{2} {( {X}_{t} - {μ}_{{S}_{t}} )}^{T} {\sum }_{{S}_{t}}^{- 1} ( {X}_{t} - {μ}_{{S}_{t} } ) ) & ( 8 )\end{matrix}$$

Formula (7) shows that an output Yₜ is represented by a linear regression model of an input Xₜ using a linear regression coefficient w_{St} of the hidden state Sₜ, and formula (8) shows that the input Xₜ is represented by a Gaussian distribution with mean μ_{St} and variance Σ_{St}. Therefore, it can be said that the hidden state Sₜ represents the variable (hidden variable) of the linear regression model representing a relationship (probabilistic relationship) between the power consumption value (output Yₜ) and the log information (input Xₜ), rather than the hidden state of the device as represented by the HMM. In addition, the output Yₜ is an objective variable in the linear regression model, and the plurality of kinds of log information as the input Xₜ corresponds to the explanatory variable in the linear regression model.

In the update of the model parameter in step S23 of the model parameter learning process having been described with reference to FIG. 4, the model parameter update unit 21 updates these parameters {w, ν₀, α, β, μ, Σ, P(S|S′), P(S₁)}. The model parameter is updated in the same manner as an EM algorithm being an iterative algorithm used in the HMM.

[Detailed Flow of Algorithm Updating Process]

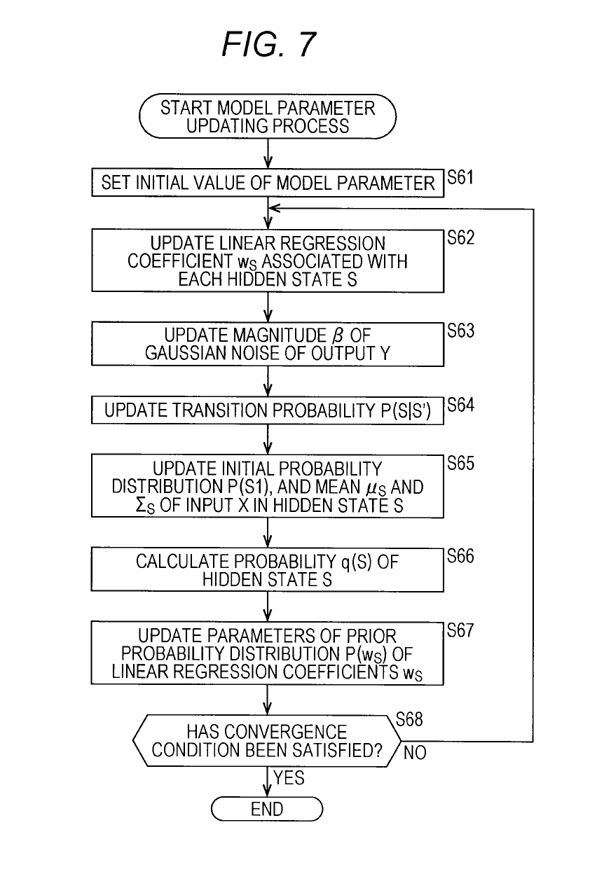

With reference to a flowchart of FIG. 7, the model parameter updating process performed as step S23 of FIG. 4 will be described in detail.

First, in step S61, the model parameter update unit 21 sets the initial value of the model parameter. The initial value of the model parameter is set by a predetermined method. For example, the initial value is determined using a random number.

In step S62, the model parameter update unit 21 updates a linear regression coefficient w_{S} associated with each hidden state S. The linear regression coefficient w_{S} is updated not by point estimation but by distribution estimation. That is, when a distribution of linear regression coefficients w_{S} associated with the hidden states S is a Gaussian distribution q(W_{S}), the Gaussian distribution q(w_{S})) of linear regression coefficients w_{S} is calculated by the following formula (9).

[Mathematical Formula 6]

log q(wₛ)=log P(wₛ)+<log P(X,Y,S|wₛ)>_{q(s)} (9)

It is noted that <•>_{q(S)} denotes an expectation value of the hidden state S. In formula (9), P(X, Y, S|w) is expressed by formula (10), wherein w={w_{S1}, w_{S2}, w_{S3}, . . . , w_{St}, . . . , w_{ST}}.

$$\begin{matrix} [ Mathematical Formula 7 ] & \\ P ( X , Y , S \vert w ) = P ( {S}_{1} ) P ( {X}_{1} , {Y}_{1} \vert {S}_{1} , {w}_{{S}_{1}} ) {\prod }_{t = 2}^{T} P ( {S}_{t} \vert {S}_{t - 1} ) P ( {X}_{t} , {Y}_{t} \vert {S}_{t} , {w}_{{S}_{t}} ) & ( 10 )\end{matrix}$$

More specifically, the mean λ_{S} and the variance τ_{S} are updated by the following formulas (11) and (12), wherein the mean of the Gaussian distribution q(w_{S}) is denoted by X_{S}, and the variance thereof is denoted by τ_{S}.

$$\begin{matrix}[ Mathematical Formula 8 ] & \\ {τ}_{S} = α + β {\sum }_{t}^{ } {q}_{t} ( S ) {X}_{t} {X}_{t}^{T} & ( 11 ) \\ {λ}_{S} = {τ}_{S}^{- 1} ( α {v}_{0} + β {\sum }_{t}^{ } {q}_{t} ( S ) {Y}_{t} {X}_{t} ) & ( 12 )\end{matrix}$$

It is noted that qₜ(S) denotes a probability of existence in the hidden state S at the time t, and expressed by formula (23) which will be described below.

In step S63, the model parameter update unit 21 updates the magnitude β of Gaussian noise of the output Y by the following formula (13).

$$\begin{matrix}[ Mathematical Formula 9 ] & \\ β = \frac{1}{T} {\sum }_{t}^{ } {\sum }_{{S}_{t}}^{ } {q}_{t} ( {S}_{t} ) ( {( {y}_{t} - {λ}_{{S}_{t}}^{T} {X}_{t} )}^{2} + {X}_{t}^{T} {τ}_{{S}_{t}} {X}_{t} ) & ( 13 )\end{matrix}$$

In step S64, the model parameter update unit 21 updates, by the following formula (14), a transition probability P(S|S′) being a probability of transition to the hidden state S at a next time from a hidden state S′ at a time.

$$\begin{matrix}[ Mathematical Formula 10 ] & \\ P ( S \vert {S}^{′} ) = {\sum }_{t}^{ } {q}_{t} ( {S}^{′} , S ) / {\sum }_{{S}^{″}}^{ } {\sum }_{t}^{ } {q}_{t} ( {S}^{′} , {S}^{″} ) & ( 14 )\end{matrix}$$

It is noted that qₜ(S′,S) denotes a probability of existence in the hidden states S′ and S at the times t and t+1, respectively.

In step S65, the model parameter update unit 21 updates, by the following formulas (15) to (17), an initial probability distribution P(S1), and the mean μ_{S} and the variance Σ_{S} of the input X in the hidden state S.

$$\begin{matrix}[ Mathematical Formula 10 ] & \\ P ( {S}_{1} ) = {q}_{1} ( {S}_{1} ) & ( 15 ) \\ {μ}_{S} = {\sum }_{t}^{ } {X}_{t} {q}_{t} ( S ) & ( 16 ) \\ {\sum }_{S}^{ } = {\sum }_{t}^{ } {q}_{t} ( S ) {( {X}_{t} - {μ}_{S} )}^{T} ( {X}_{t} - {μ}_{S} ) & ( 17 )\end{matrix}$$

In step S66, the model parameter update unit 21 calculates a probability q(S) of the hidden state S expressed by the following formula (18).

[Mathematical Formula 12]

log q(S)=<log p(x,y,s|w)>_{q(w)} (18)

Specifically, the model parameter update unit 21 calculates the probability qₜ(S) of existence in the state S at the time t, according to the following procedure.

First, the model parameter update unit 21 calculates, by the following formulas (19) and (20), forward likelihood α(Sₜ) and backward likelihood β(Sₜ) in the state Sₜ.

$$\begin{matrix}[ Mathematical Formula 13 ] & \\ α ( {S}_{t} ) = p ( {X}_{t} , {Y}_{t} \vert {S}_{t} ) {\sum }_{{S}_{t - 1}}^{ } α ( {S}_{t - 1} ) p ( {S}_{t} \vert {S}_{t - 1} ) & ( 19 ) \\ β ( {S}_{t} ) = {\sum }_{{S}_{t + 1}}^{ } β ( {S}_{t + 1} ) p ( {X}_{t + 1} \vert {S}_{t + 1} ) p ( {S}_{t + 1} \vert {S}_{t} ) & ( 20 )\end{matrix}$$

It is noted that p(Xₜ, Yₜ|Sₜ) is calculated by

$$\begin{matrix}[ Mathematical Formula 14 ] & \\ p ( {X}_{t} , {Y}_{t} \vert {S}_{t} ) = exp ( \frac{- β}{2} \{ {( {y}_{t} - {λ}_{{S}_{t}} {X}_{t} )}^{2} + {X}_{t}^{T} {τ}_{{S}_{t}} {X}_{t} \} ) . & ( 21 )\end{matrix}$$

Next, the model parameter update unit 21 calculates, by the following formula (22), a probability qₜ(S, S′) of existence in the hidden states S and S′ at the times t and t+1, respectively.

$$\begin{matrix}[ Mathematical Formula 15 ] & \\ {q}_{t} ( S , {S}^{′} ) = \frac{α ( {S}_{t - 1} ) p ( {X}_{t} \vert {S}_{t} ) p ( {S}_{t} \vert {S}_{t - 1} ) β ( {S}_{t} )}{p ( X )} & ( 22 )\end{matrix}$$

With the use of the obtained probability qₜ(S,S′), the model parameter update unit 21 calculates, by formula (23), the probability qₜ(S) of existence in the state S at the time t.

$$\begin{matrix}[ Mathematical Formula 16 ] & \\ {q}_{t} ( S ) = {\sum }_{{S}^{′}}^{ } {q}_{t} ( S , {S}^{′} ) & ( 23 )\end{matrix}$$

In step S67, the model parameter update unit 21 updates parameters of the prior probability distribution P(w_{S}) of linear regression coefficients w_{S}, or the mean ν₀ and variance α⁻¹.

The mean ν₀ and the variance α⁻¹ conceptually satisfies the following condition.

$$\begin{matrix}[ Mathematical Formula 17 ] & \\ ( {ν}_{0} , α ) = Arg min {\sum }_{S}^{ } KL ( q ( {w}_{S} ) ) \vert \vert N ( {w}_{S} ; {ν}_{0} , {α}^{- 1} ) ) & ( 24 )\end{matrix}$$

It is noted that N(w_{S};ν₀, α⁻¹) represents that probability variables w_{S} are normally distributed with the mean ν₀ and the variance α⁻¹, and KL(q(w_{S})∥N(w_{S};ν₀, α⁻¹)) denotes the Kullback-Leibler divergence between q(w_{S}) and N(w_{S}; ν₀, α⁻¹). Further, Argmin represents variables (ν₀ and variance α) for minimizing the sum (Σ) of KL(q(w_{S})∥N(w_{S};ν₀, α⁻¹)) in all the hidden states S.

Specifically, the mean ν₀ and variance α⁻¹ of the prior probability distribution P(w_{S}) is calculated by the following formulas.

$$\begin{matrix}[ Mathematical Formula 18 ] & \\ {ν}_{0} = \frac{1}{N} {\sum }_{S}^{ } {λ}_{S} & ( 25 ) \\ {α}_{k}^{- 1} = \frac{1}{N} ( {\sum }_{S}^{ } {τ}_{S , k} + {\sum }_{S}^{ } {( {λ}_{S , k} - {ν}_{0 , k} )}^{2} ) & ( 26 )\end{matrix}$$

A subscript k denotes k-th component.

In step S68, the model parameter update unit 21 determines whether a convergence condition of the model parameter has been satisfied. For example, when a repetition count of the processes of steps S62 to 68 reaches a preset predetermined count, or when a variation of a state likelihood generated by the update of the model parameter is within a predetermined value range, the model parameter update unit 21 determines that the convergence condition of the model parameter has been satisfied.

In step S68, when it is determined that the convergence condition of the model parameter has not been satisfied yet, the process returns to step S62, and the processes of steps S62 to S68 are repeated.

On the other hand, in step S68, when it is determined that the convergence condition of the model parameter has been satisfied, the model parameter update unit 21 finishes the model parameter updating process.

It is to be understood that a calculation order of the model parameter to be updated does not need to be performed in the above-mentioned order of steps S62 to S67, but may be performed in any order.

When the model parameter is updated according to the above-mentioned model parameter updating process, a large number of variances α⁻¹ₖ have infinite values. The variances α⁻¹ₖ are selected from the variances α⁻¹ of the prior probability distribution P(w_{S}) of the linear regression coefficients w_{S} calculated in step S67. When the variance α⁻¹ₖ has the infinite value, the k-th components of all the linear regression coefficients w_{S} is restricted to 0, since a mean ν_{0,k} is set to 0. This represents that the k-th component of the input X is not so important and the input X with the k-th component does not need to be used.

Therefore, in an unnecessary log information determination process performed in step S25 of the model parameter learning process having been described with reference to FIG. 4, the log selection unit 23 determines whether the k-th component of the linear regression coefficient w_{S} is smaller than a predetermined threshold (e.g., 0.01). The log information corresponding to a component of the linear regression coefficient w_{S} smaller than the predetermined threshold is determined as the unnecessary log information. The log selection unit 23 selectively controls the log acquisition unit 13 so that the log information having been determined to be unnecessary is not used later.

It is noted that, when a new kind of log information to be acquired is increased, the increased log information needs to be added to perform again the learning process or the data collection process illustrated in FIG. 3 and the model parameter learning process illustrated in FIG. 4. In this configuration, the initial value of the model parameter can employ the model parameter at the current time which has been stored in the model parameter storage unit 22.

[Detailed Power Consumption Estimation Process]

Next, the model parameter having been learned as described above is used to describe in detail the power consumption estimation process performed in step S44 of FIG. 5.

In the power consumption estimation process, only the time-series log data is acquired from the log time-series input unit 15. The power consumption estimation unit 18 finds a hidden state S*ₜ satisfying the following formula (27), wherein the time-series log data having been acquired in the power consumption estimation process are denoted by {X^{d}₁, X^{d}₂, X^{d}₃, . . . , X^{d}ₜ, . . . , X^{d}_{T}}.

$$\begin{matrix}[ Mathematical Formula 19 ] & \\ {S}_{t}^{*} = Arg {min}_{\{ {S}_{t} \}} P ( \{ {S}_{t} , {X}_{t}^{d} \} ) & ( 27 )\end{matrix}$$

It is noted that a joint probability distribution P({Sₜ, X^{d}ₜ}) between the hidden state Sₜ at the time t, and log information X^{d}ₜ is expressed by [Mathematical Formula 20].

$$P ( \{ {S}_{t} , {X}_{t}^{d} \} ) = P ( {S}_{1} ) P ( {X}_{1}^{d} \vert {S}_{1} ) {\prod }_{t = 2}^{T} P ( {S}_{t} \vert {S}_{t - 1} ) P ( {X}_{t}^{d} \vert {S}_{t} ) \qquad ( 28 )$$

In formula (27), the hidden state Sₜ at the time t during state transition (maximum likelihood state sequence) is found as S*ₜ. In the state transition, the likelihood of observation of the acquired time-series log data {X^{d}₁, X^{d}₂, X^{d}₃, . . . , X^{d}ₜ, . . . , X^{d}_{T}} is maximized. The maximum likelihood state sequence can be obtained using a Viterbi algorithm.

The Viterbi algorithm and the EM algorithm (Baum-Welch algorithm) are described in detail, for example, in “Pattern Recognition and Machine Learning (Information Science and Statistics)”, Christopher M. BishopSpringer, New York, 2006, p. 347, p. 333.

After finding the hidden state S*ₜ for satisfying formula (27), the power consumption estimation unit 18 finds (estimates) a power consumption estimation value Y*ₜ by the following formula (29).

[Mathematical Formula 21]

Yₜ*=λ_{S}_{ₜ}_{*}^{T}Xₜ (29)

Accordingly, the power consumption estimation value Y*ₜ is derived from an inner product of input Xₜ and mean λ_{St} of the linear regression coefficient w_{S} in the hidden state S*ₜ.

In step S44 of FIG. 5, the power consumption estimation unit 18 estimates the power consumption value Y*ₜ at the current time, as described above.

[Exemplary Deformation to HMM]

It can be said that the algorithm of the HMM+RVM having been described above is obtained by applying the RVM to the HMM. Accordingly, when the above-mentioned model parameter of the HMM+RVM is set to a predetermined condition, the HMM+RVM also serves as a normal HMM. Estimation and application of the normal HMM as the power consumption variation model will be described below.

First, the deformation from the HMM+RVM to the HMM will be described.

It is assumed that input X˜ to the HMM is (Dx+1)th time-series log data X, as the input X, added with a new component in the HMM+RVM. That is, input X˜ₜ at a time t in the HMM is expressed by

$$\begin{matrix}[ Mathematical Formula 22 ] & \\ {X}_{\tilde{t}} = ( \begin{matrix}{X}_{t} \\ 1\end{matrix} ) . & ( 30 )\end{matrix}$$

The variance α⁻¹ (inverse of a) of the prior probability distribution P(w_{S}) of the linear regression coefficients w_{S} is configured as follows, in which the (Dx+1)th component is set to an infinite value, and the other components are set to 0. Therefore, the prior probability distribution P(w_{S}) of the linear regression coefficients w_{S} has fixed parameters.

$$\begin{matrix}[ Mathematical Formula 23 ] & \\ {α}_{k} = \begin{matrix}0 \\ ∞\end{matrix} \begin{matrix}: k \neq ( Dx + 1 ) \\ : k = ( Dx + 1 )\end{matrix} & ( 31 )\end{matrix}$$

In this configuration, the probability model of the HMM+RVM expressed by formula (4) having been described above can be expressed as the following formula (32).

$$\begin{matrix} [ Mathematical Formula 24 ] & \\ P ( \{ {S}_{t} , {Y}_{t} , {X}_{t} \} ) = P ( {S}_{1} ) P ( {X}_{1} , {Y}_{1} \vert {S}_{1} ) {\prod }_{t = 2}^{T} P ( {S}_{t} \vert {S}_{t - 1} ) P ( {X}_{t} , {Y}_{t} \vert {S}_{t} ) & ( 32 )\end{matrix}$$

An observation probability P(Xₜ, Yₜ|Sₜ) in formula (32) is deformed to [Mathematical Formula 25], and thus formula (32) results in the probability model of the normal HMM expressed as formula (1).

P(Xₜ,Yₜ|Sₜ)=P(Yₜ|Sₜ)P(Xₜ|Sₜ) (33)

It is noted that ρ_{St} of the observation probability P(Yₜ|Sₜ) in formula (2) corresponds to the (Dx+1)th component of the linear regression coefficient w_{S}.

When the normal HMM is employed as the power consumption variation model, the prior probability distribution P(w_{S}) of the linear regression coefficients w_{S} has the fixed parameters, as described above. Therefore, the process of step S68 of FIG. 7 is omitted. Additionally, since the prior probability distribution P(w_{S}) has the fixed parameters, the process of step S25 in the model parameter learning process of FIG. 4 is also omitted.

Accordingly, the normal HMM employed as the power consumption variation model inhibits the selection control of the unnecessary kind of log information by the log selection unit 23. That is, in the HMM+RVM, even if multiple kinds of log information are given as the input X, the information processor 1 can select (automatically) only log information required for power estimation. Therefore, the person does not need to determine or select the kind of data to be acquired which is used for estimation of power consumption, and a burden on the person can be reduced. After one cycle of the learning process has been finished, the unnecessary log information does not need to be acquired in subsequent data collection process, model parameter learning process, and power consumption estimation process. Therefore, the amount of log information to be acquired and the amount of log information to be calculated are reduced, and further a processing time is also reduced. That is, according to the probability model using the HMM+RVM of the present technique, only the log information useful for the estimation is used to perform efficient estimation.

When the normal HMM is employed as the power consumption variation model, the variance α⁻¹ (inverse of α) of the prior probability distribution P(w₃) of the linear regression coefficients W_{S} is expressed by formula (31), in the power consumption estimation process. Therefore, a formula for finding the power consumption estimation value Y*ₜ is simplified as the following formula (34), based on formula (29) of the HMM+RVM.

[Mathematical Formula 26]

Yₜ*=ρ_{S}_{ₜ}_{*} (34)

When the normal HMM is employed as the power consumption variation model, learning is performed based on the time-series power consumption data, in the model parameter learning process. Formula (35) is a formula used to find a probability distribution q(S) in the hidden state S, when the learning model is the HMM.

[Mathematical Formula 27]

log q(S)=ωx log P(X|S)+θy log P(Y|S)+log P(S) (35)

It is noted that ωₓ is a weight coefficient for the observed time-series log data, and ω_{y} is a weight coefficient for the time-series power consumption data. In formula (35), the weight coefficient ω_{y} for the time-series power consumption data is set to be larger than the weight coefficient ωₓ for the time-series log data, the learning is performed based on the time-series power consumption data.

In the above-mentioned embodiment, the log information obtained at the time t is used directly for the observed data Xₜ at the time t, but when needed, a value obtained by subjecting the log information to predetermined data processing can be used as the observed data Xₜ at the time t.

For example, Bt pieces of log information acquired from a time t−Δt, Δt hours before the time t, to the time t may be the observed data Xₜ at the time t. In this configuration, the observed data Xₜ includes Dx by Bt matrix of vectors.

Further, for example, any of a predetermined kind of log information xₜⁱ (i=1, 2, . . . , Dx) selected from among the plurality of kinds (Dx pieces) of log information xₜ¹, xₜ², . . . , xₜ^{Dx} at the time t may include, as an element of the input X, a value log (1+xₜⁱ) converted using a function f(x)=log(1+x).

A learning model of the present invention employs a learning model based on the HMM. HMM is employed to permit estimation performed in consideration of not only an operating state at the current time but also a history of past operating states up to an operating state at the current time. Therefore, the power consumption can be highly precisely estimated, compared with the linear estimation according to the Patent Document 1. For example, continuous load put on a CPU for a certain time period may lead to increase in power consumption due to increase in temperature of the CPU, rotation of a fan, or the like. According to the present embodiment, the learning model learns, as a history, the high load condition of the CPU for the certain time period, and outputs an estimation result.

In the above-described embodiments, an exemplary application of the HMM+RVM to the power consumption estimation process has been described, in which the HMM+RVM is the learning model of the present technique, and uses the time-series power consumption data and the time-series log data as the observed time-series data.

However, the estimation process using the HMM+RVM of the present technique can be applied to estimation other than the power consumption estimation. Another exemplary application thereof will be described briefly.

For example, the present technique can be applied to an attitude estimation process for estimating an attitude of an object such as a robot. In this process, time-series sensor data obtained from a plurality of acceleration sensors attached to the object such as the robot, and time-series position data being positional time-series data representing the attitude of the object are defined as the input X and the output Y, respectively, in the learning process. In the estimation process, the time-series sensor data can be used to estimate a current attitude of the object.

According to the learning process of the present technique using a learning model for attitude estimation, the log selection unit 23 can eliminate unnecessary sensor data of the acceleration sensor. It is difficult for the linear estimation using only sensor data at the current time to determine the current attitude of the object, but acceleration values accumulated (integrated) using the time-series sensor data can be employed to estimate change in the attitude of the object.

Further, the present technique can be applied to, for example, a process for estimating “noisiness” to a person based on a feature sequence of video content. In this configuration, time-series data of features of the video content (e.g., features of sound volume or image), and time-series data of the “noisiness” to the person are defined as the input X and the output Y, respectively, in the learning process.

The “noisiness” to the person depends on not the sound volume simply but a context or the kind of sound. An index of the “noisiness” depends on the context of the video content (preceding content and sound of the video content). For example, in a climax scene, even if the sound volume is raised from “3” to “4”, the person does not feel noisy, but when the sound volume suddenly raised to “4” in a quiet scene, from the sound volume “1”, the person may feel noisy. Accordingly, it is difficult to precisely estimate the “noisiness” based on only the features at the current time. However, it is possible to highly precisely estimate the “noisiness” to the person by defining time-series data of the features of the video content as the input X.

According to the learning process of the present technique using the learning model for estimating the “noisiness”, the log selection unit 23 controls determination and disuse of unnecessary features from the acquired features of the video content.

Further, the present technique can be applied to, for example, a process for estimating a user's TV viewing time of the day based on time-series operation data representing operation statuses of a user's smartphone. In this configuration, a time index t is set to a day (day basis), and time-series operation data representing the operation status of the user's smartphone, and time-series data of the user's TV viewing time are defined as the input X and the output Y, respectively, in the learning process. Thereby, in the estimation process, time-series operation data representing the operation status of the user's smartphone of a day is used to estimate a TV viewing time of the day.

A pattern of human behavior has history dependency, for example, “if a person watches TV much on a day, he/she will be likely to watch TV much also in a week”. Accordingly, a highly precise estimation can be performed by using the time-series data during a predetermined period such as a few days or a few weeks, compared with estimation based on only a daily behavior situation of the user. It is noted that an item to be estimated may be for example a “car riding time” or a “login time for a social networking service (SNS) such as Facebook (registered trademark)” in addition to the “TV viewing time”.

The above-mentioned series of processes may be performed by hardware or software. When the above-mentioned series of processes is performed by the software, a program constituting the software is installed in a computer. The computer includes a computer incorporated into dedicated hardware, a computer, for example, a general-purpose personal computer configured to execute various functions by installing various programs, or the like.

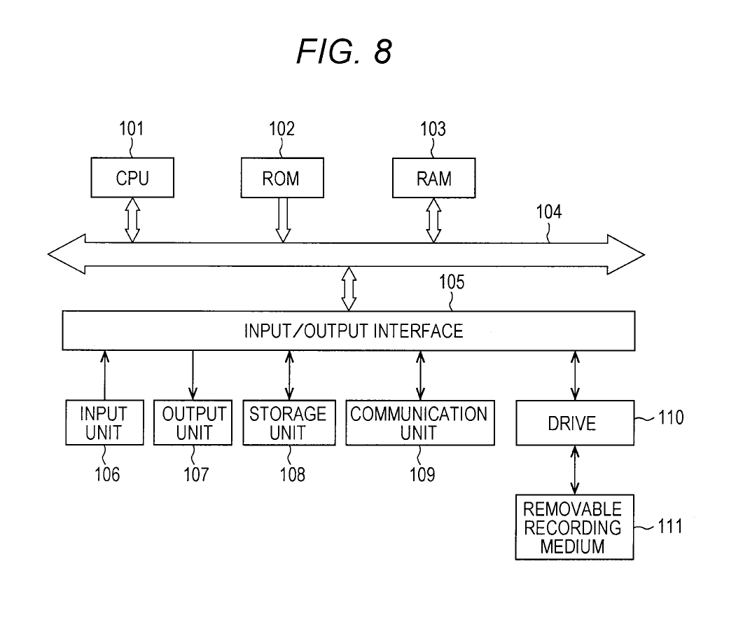

FIG. 8 is a block diagram illustrating an exemplary configuration of the hardware of the computer performing the above-described series of processes according to the program.

In the computer, a central processing unit (CPU) 101, a read only memory (ROM) 102, and a random access memory (RAM) 103 are connected to each other through a bus 104.

Further, the bus 104 is connected to an input/output interface 105. The input/output interface 105 is connected to an input unit 106, an output unit 107, a storage unit 108, a communication unit 109, and a drive 110.

The input unit 106 includes a keyboard, a mouse, and a microphone. The output unit 107 includes a display, and a speaker. The storage unit 108 includes a hard disk and a non-volatile memory. The communication unit 109 includes a network interface and the like. The drive 110 drives a removable recording medium 111 such as a magnetic disk, an optical disk, a magnetooptical disk, or a semiconductor memory.

In the computer configured as described above, the CPU 101 loads the program stored for example in the storage unit 108 into the RAM 103 through the input/output interface 105 and the bus 104, and executes the program. Thereby, the above-mentioned series of processes is performed.

In the computer, the program is installed in the storage unit 108 through the input/output interface 105, by mounting the removable recording medium 111 to the drive 110. Additionally, the program can be received at the communication unit 109 through a wired or wireless transmission medium such as a local area network, the Internet, or digital satellite broadcasting to be installed in the storage unit 108. The program may be previously installed in the ROM 102 or the storage unit 108.

It is noted that the program executed by the computer may be a program for executing the processes in time series along the order having been described in the present description, or a program for executing the processes in parallel or with necessary timing, for example, when evoked.

It is noted that, in the present description, the steps having been described in the flowcharts may be carried out in parallel or with necessary timing, for example, when evoked, even if the steps are not executed in time series along the order having been described therein, as well as when the steps are executed in time series.

It is to be understood that, in the present description, the system represents an assembly of a plurality of component elements (e.g., devices, modules (components)), regardless of whether all the component elements are inside the same casing. Accordingly, the system includes a plurality of apparatuses housed in different casings and connected to each other through a network, and one apparatus housing a plurality of modules in one casing.

The present technique is not intended to be limited to the above-mentioned embodiments, and various modifications and variations may be made without departing from the scope and spirit of the present technique.

For example, a combination of all or part of the above-mentioned plurality of embodiments may be employed.

For example, the present technique may include a cloud computing configuration for sharing one function between the plurality of apparatuses through the network.

The steps having been described in the above-mentioned flowchart can be performed by the one apparatus, and further shared between the plurality of apparatuses.

Further, when one step includes a plurality of processes, the plurality of processes of the one step may be performed by the one apparatus, and further shared between the plurality of apparatuses.

It is noted that the present technique also may include the following configuration.

(1)

An information processor including:

an acquisition unit configured to acquire objective time-series data being time-series data corresponding to an objective variable to be estimated and a plurality of pieces of explanatory time-series data being time-series data corresponding to a plurality of explanatory variables for explaining the objective variable;

a learning unit configured to learn a parameter of a probability model, using the acquired objective time-series data and the plurality of pieces of explanatory time-series data;

a selection unit configured to select, based on the parameter of the probability model having been obtained by the learning, the explanatory variables corresponding to the explanatory time-series data to be acquired by the acquisition unit; and

an estimation unit configured to estimate the objective variable value using the plurality of pieces of explanatory time-series data having been acquired by the acquisition unit based on a selection result of the selection unit.

(2)

The information processor according to (1), in which the learning unit learns a relationship between the objective variable and the plurality of explanatory variables, using a hidden Markov model.

(3)

The information processor according to (2), in which the objective variable is represented by a linear regression model with linear regression coefficients corresponding to a hidden state of the hidden Markov model one by one, and the explanatory variables.

(4)

The information processor according to (3), in which the selection unit selects the explanatory variable having the linear regression coefficient smaller than a predetermined threshold, as an explanatory variable without time-series data acquired by the acquisition unit.

(5)

An information processing method of an information processor including:

acquiring objective time-series data being time-series data corresponding to an objective variable to be estimated, and plurality of pieces of explanatory time-series data being time-series data corresponding to a plurality of explanatory variables for explaining the objective variable;

learning a parameter of a probability model using the acquired objective time-series data and the plurality of pieces of explanatory time-series data;

selecting, based on the parameter of the probability model having been obtained by the learning, the explanatory variables corresponding to the explanatory time-series data to be acquired; and

estimating an objective variable value using the plurality of pieces of explanatory time-series data having been acquired based on a selection result.

(6)

A program for causing a computer to function as:

an acquisition unit configured to acquire objective time-series data being time-series data corresponding to an objective variable to be estimated and a plurality of pieces of explanatory time-series data being time-series data corresponding to a plurality of explanatory variables for explaining the objective variable;

a learning unit configured to learn a parameter of a probability model using the acquired objective time-series data and the plurality of pieces of explanatory time-series data;

a selection unit configured to select, based on the parameter of the probability model having been obtained by the learning, the explanatory variables corresponding to the explanatory time-series data to be acquired by the acquisition unit; and

an estimation unit configured to estimate the objective variable value using the plurality of pieces of explanatory time-series data having been acquired by the acquisition unit based on a selection result of the selection unit.

### REFERENCE SIGNS LIST

1 information processor
11 power consumption measurement unit
12 power consumption time-series input unit
13 log acquisition unit
15 log time-series input unit
16 time-series history storage unit
17 model learning unit
18 power consumption estimation unit
19 estimated power consumption display unit
21 model parameter update unit
22 model parameter storage unit
23 log selection unit

1. An information processor comprising:
an acquisition unit configured to acquire objective time-series data being time-series data corresponding to an objective variable to be estimated and a plurality of pieces of explanatory time-series data being time-series data corresponding to a plurality of explanatory variables for explaining the objective variable;
a learning unit configured to learn a parameter of a probability model, using the acquired objective time-series data and the plurality of pieces of explanatory time-series data;
a selection unit configured to select, based on the parameter of the probability model having been obtained by the learning, the explanatory variables corresponding to the explanatory time-series data to be acquired by the acquisition unit; and
an estimation unit configured to estimate the objective variable value using the plurality of pieces of explanatory time-series data having been acquired by the acquisition unit based on a selection result of the selection unit.

2. The information processor according to claim 1, wherein the learning unit learns a relationship between the objective variable and the plurality of explanatory variables, using a hidden Markov model.

3. The information processor according to claim 2, wherein the objective variable is represented by a linear regression model with linear regression coefficients corresponding to a hidden state of the hidden Markov model one by one, and the explanatory variables.

4. The information processor according to claim 3, wherein the selection unit selects the explanatory variable having the linear regression coefficient smaller than a predetermined threshold, as an explanatory variable without time-series data acquired by the acquisition unit.

5. An information processing method of an information processor, comprising:
acquiring objective time-series data being time-series data corresponding to an objective variable to be estimated, and a plurality of pieces of explanatory time-series data being time-series data corresponding to a plurality of explanatory variables for explaining the objective variable;
learning a parameter of a probability model using the acquired objective time-series data and the plurality of pieces of explanatory time-series data;
selecting, based on the parameter of the probability model having been obtained by the learning, the explanatory variables corresponding to the explanatory time-series data to be acquired; and
estimating an objective variable value using the plurality of pieces of explanatory time-series data having been acquired based on a selection result.

6. A program for causing a computer to function as:
an acquisition unit configured to acquire objective time-series data being time-series data corresponding to an objective variable to be estimated and a plurality of pieces of explanatory time-series data being time-series data corresponding to a plurality of explanatory variables for explaining the objective variable;
a learning unit configured to learn a parameter of a probability model using the acquired objective time-series data and plurality of pieces of explanatory time-series data;
a selection unit configured to select, based on the parameter of the probability model having been obtained by the learning, the explanatory variables corresponding to the explanatory time-series data to be acquired by the acquisition unit; and
an estimation unit configured to estimate the objective variable value using the plurality of pieces of explanatory time-series data having been acquired by the acquisition unit based on a selection result of the selection unit.
